(19) United States
(12) Patent Application Publication
(10) Pub. No.: US 2012/0183938 A1
(43) Pub. Date: Jul. 19, 2012

(54) APPARATUS AND METHODS FOR GIVING AND RECEIVING PERFORMANCE RECOGNITION

(76) Inventors: David Hilton, North Salt Lake, UT (US); Valerie Leach, Salt Lake City, UT (US); Cathie Lewis, Taylorsville, UT (US); Lori Janes-Young, South Jordan, UT (US)

(21) Appl. No.: 13/349,364

(22) Filed: Jan. 12, 2012

Related U.S. Application Data
(60) Provisional application No. 61/432,942, filed on Jan. 14, 2011.

(51) Int. Cl. G09B 19/00

(52) U.S. Cl. 434/238

(57) ABSTRACT

Data processing systems are presented for facilitating performance recognition among a plurality of users. A user data processing system may obtain data associated with a particular user recognition space, and may display graphical information related to the data associated with the user recognition space. The user data processing system may further display one or more recognition indicators. A recognition indicator may be adapted to indicate receipt of a recognition token, that a recognition token has been sent to another user, and/or that a nomination has been submitted for recognition of another user.

### CLAIM OF PRIORITY UNDER 35 U.S.C. §119

The present application for patent claims priority to Provisional Application No. 61/432,942 entitled “Virtual Cork Board for Performance Recognition” filed Jan. 14, 2011, the entire disclosure of which is hereby expressly incorporated by reference herein.

### TECHNICAL FIELD

The present disclosure relates generally to performance recognition. More specifically, various implementations of the present disclosure relate to methods, devices and systems for giving and receiving recognition tokens in a work group, or team setting.

### BACKGROUND

Recognition in a team setting is typically conveyed either verbally or by a short message. In general, if a person wishes to retain some record of recognition given or received, that person must write down each time recognition is received verbally, and must create some space for saving letters, notes, emails and other recognition messages received. It is even more burdensome to keep a record of recognition that a person gives to others. There is currently no means for enabling a person to easily give and receive recognition for positive performance, and then to keep a record of the recognition given and received that can be visually reviewed by a user.

### BRIEF SUMMARY

Various embodiments of the present disclosure include devices and methods for facilitating the giving and receiving of recognition and nominations for recognition, as well as for retaining a record of recognition given and received. In one or more embodiments, a data processing system includes a processing circuit coupled to a communications interface and to a display. The processing circuit may be adapted to obtain data associated with a user recognition space via the communications interface, and display graphical information related to the data associated with the user recognition space. The processing circuit may further be adapted to display at least one recognition indicator. A recognition indicator can be adapted to indicate receipt of a recognition token, that a recognition token has been sent to another user, and/or that a nomination has been submitted for recognition of another user.

Additional embodiments of the present disclosure relate to methods operational on a data processing system. One or more implementations of such methods may include obtaining data associated with a user recognition space. Graphical information related to the data associated with the user recognition space may be displayed. At least one recognition indicator may also be displayed. The at least one recognition indicator may be adapted to indicate receipt of a recognition token, that a recognition token has been sent to another user, and/or that a nomination has been submitted for recognition of another user.

Further embodiments of the present disclosure include processor-readable media including processor-executable instructions operational on a server. The processor-executable instructions may be adapted to cause the processor to obtain data associated with a user recognition space, and display graphical information related to the data associated with the user recognition space. The processor-executable instructions may further be adapted to cause the processor to display at least one recognition indicator. The at least one recognition indicator may be adapted to indicate receipt of a recognition token, that a recognition token has been sent to another user, and/or that a nomination has been submitted for recognition of another user.

### BRIEF DESCRIPTION OF THE SEVERAL VIEWS OF THE DRAWINGS

Exemplary embodiments of the disclosure will become more fully apparent from the following description and appended claims, taken in conjunction with the accompanying drawings. Understanding that these drawings depict only exemplary embodiments and are, therefore, not to be considered limiting of the disclosure's scope, the exemplary embodiments of the disclosure will be described with additional specificity and detail through use of the accompanying drawings in which:

FIG. 1 is a block diagram illustrating an environment in which one or more implementations of the present disclosure may be employed;

FIG. 2 illustrates a depiction of a screen shot of an active and customized user recognition space according to at least one non-limiting example;

FIG. 3 is a block diagram illustrating a network environment wherein users of a work group may access their user recognition space and may give and receive recognition tokens;

FIG. 4 is a flow diagram illustrating an operation of sending a nomination or a recognition token from a first user and receiving the sent nomination or recognition token by a second user according to at least one example;

FIG. 5 is a flow diagram illustrating an operation of a server identifying qualifying users and sending a recognition token to each qualifying user, according to at least one example;

FIG. 6 is a block diagram illustrating a data processing system implemented as a user system according to at least one example;

FIG. 7 is a flow diagram illustrating an example of at least one implementation of a method operational on a user data processing system;

FIG. 8 is a flow diagram illustrating an example of a method operational on the data processing system according to at least one implementation for sending a recognition token to another user;

FIG. 9 is a flow diagram illustrating an example of a method operational on the data processing system according to at least one implementation for sending a nomination for another user to receive recognition;

FIG. 10 is a flow diagram illustrating an example of a method operational on the data processing system according to at least one implementation for receiving recognition token or a nomination for recognition;

FIG. 11 is a block diagram illustrating a data processing system implemented as a server according to at least one example;

FIG. 12 is a flow diagram illustrating an example of at least one implementation of a method operational on a server;

FIG. 13 is a flow diagram illustrating an example of a method operational on a server according to at least one implementation for facilitating a modification to a user recognition space; and

FIG. 14 is a flow diagram illustrating an example of a method operational on a server according to at least one implementation for sending a recognition token to a user.

### DETAILED DESCRIPTION

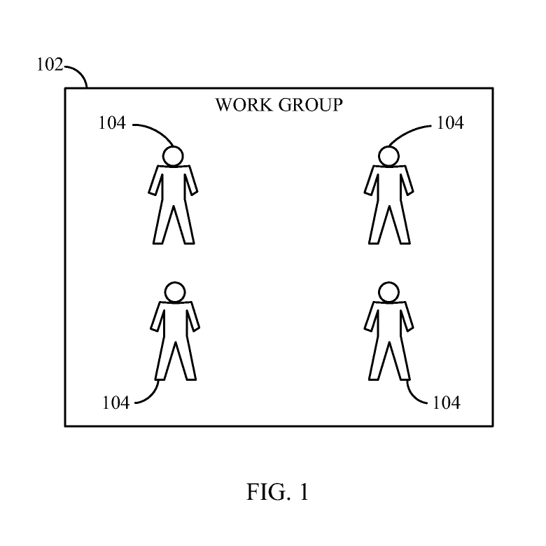

Various embodiments of the present disclosure relate to devices, systems and methods for receiving and giving recognition tokens in response to a person's positive performance. FIG. 1 is a block diagram illustrating an environment in which one or more embodiments of the present disclosure may be employed. Various embodiments of the present disclosure may find utility, for example, with a work group 102 comprising two or more group members, identified as users 104, who may be working together in some manner. A work group 102 may be formed of persons (e.g. users 104) working together for a common result. By way of example and not limitation, a work group 102 may be formed of persons (e.g., users 104) associated with a business, a particular business department, a project team, a religious organization, a charity, a professional organization, etc., or some combination of unrelated organizations (e.g., persons of different businesses working on a joint venture).

According to at least one feature, a user recognition space may be provided for each user 104 of the work group 102. The user recognition space may comprise a virtual platform accessible by each user 104 and adapted for facilitating the giving of and receipt of recognition tokens associated with a user's positive performance. The user recognition space also facilitates the retaining a record of recognition tokens given and received. The user recognition space associated with each user may be unique for the particular user. For example, each respective user recognition space is adapted to show the recognition received and given for each particular user without showing received recognition for any other user. In addition to each user recognition space being unique by including the recognition tokens associated with that particular user (e.g., recognition sent and/or received), each user recognition space may include one or more features that may be customized by each user. The recognition space for each user of a plurality of users may be stored on one or more data processing devices implemented as servers. Accordingly, as a user customizes their associated user recognition space, those customizations are stored by the server for future retrieval and use. In at least some implementations, the customizable features may be edited by clicking on a feature of a link in the graphical user interface of the user recognition space.

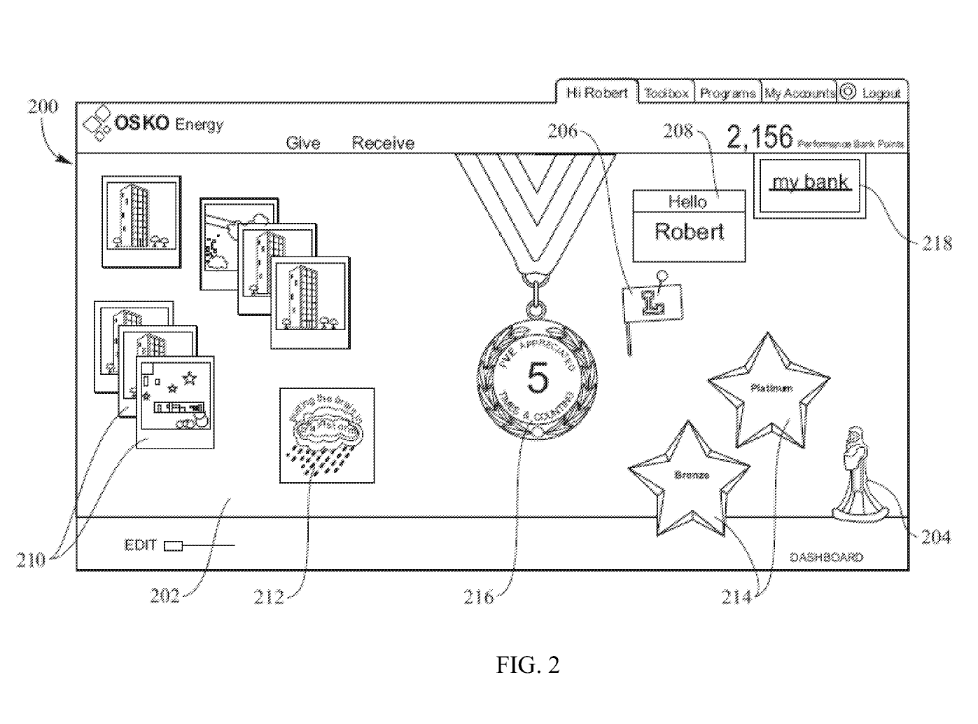

FIG. 2 illustrates a depiction of a screen shot of an active and customized user recognition space 200 according to one non-limiting example. The user recognition space 200 may operate within a web browser, since the user recognition space can be accessed from a server. The user recognition space 200 can be adapted to enable various features to be customized by the user. For example, the user may be able to select or customize a background color 202 of the user recognition space 200, a mascot graphic 204, a flag 206, a nametag 208, as well as other graphical objects. In some examples, the user may upload one or more graphics, such as a personal image or photo. According to various examples, the location for one or more of these various customizable features may be moved in the user recognition space 200 according to the user's preferences. In some examples, one or more of the customizable features may be fixed in the user recognition space, and not moveable by the user.

FIG. 2 also illustrates some examples of received virtual recognition tokens. For example, the illustrated user recognition space 200 includes a plurality of electronic card (eCard) thumbnails 210, electronic button (eButton) thumbnails 212, and gold stars 214. Other recognition tokens may include an electronic message (e.g., a “thank you” message), other electronic graphics (e.g., a virtual trophy), a combination of a message and a graphic (e.g., an electronic card, electronic button), or other virtual tokens. In addition to the received recognition tokens, the user recognition space 200 also shows a medallion 216 that is configured to display a number representing the sum total of all recognition tokens and/or nominations given to others by the user.

Each eCard thumbnail 210 may be associated with a respective eCard. Similarly, each eButton thumbnail may be associated with a respective eButton. The user may select an eCard thumbnail 210 or eButton thumbnail 212, for example by clicking on or scrolling over the thumbnail, whereupon the associated eCard or eButton may be opened for the user to view.

According to a feature, a bank (or user bank) 218 may be included and displayed in the user recognition space 200 for recording and tracking a number of points a user has received. Such points may be associated with receiving recognition tokens, giving recognition tokens to other users and/or other activities. A user may have one or more banks, and the user recognition space 200 may be adapted to display the number of points in each bank when the user selects (clicks on, scrolls over, etc.) the “my bank” graphic 218 in the user recognition space 200. The user recognition space may also display a sum total of the performance bank points the user currently has.

According to a feature, the availability and selection of any or all of the foregoing features may be managed at various levels. For example, a plurality of features may be available for use by any organization wishing to use any implementation of the present disclosure. A company or organization may be given the ability to choose which of the plurality of features they wish to make available to the users. For example, the company or organization may choose a single background color, a particular mascot, flag, or other feature that will be used for all users. In addition or alternatively, the company or organization may be given the ability to block certain features completely. For example, the company or organization may choose to not include any mascot. Accordingly, the user recognition space viewable by each user would not include any options for adding a mascot.

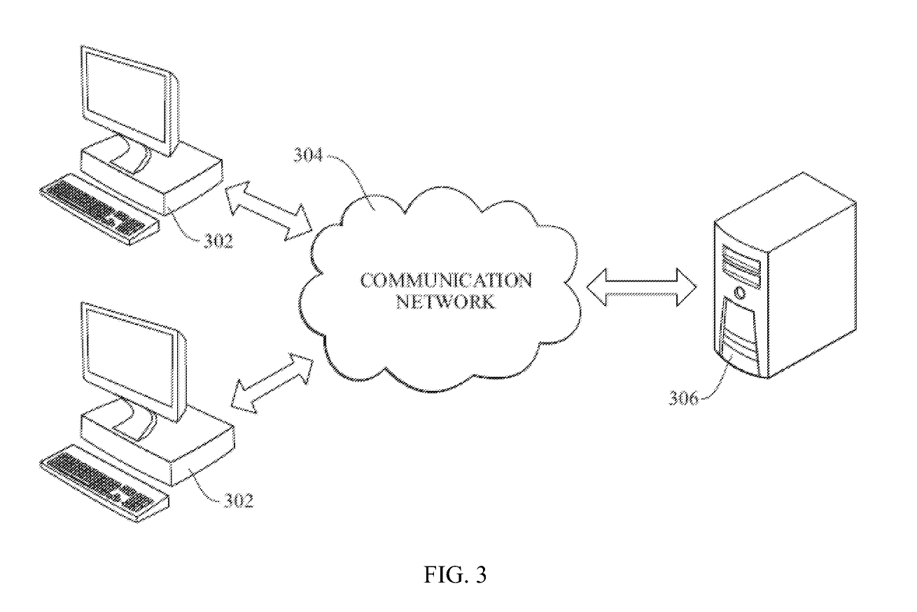

FIG. 3 is a block diagram illustrating a network environment wherein users 104 of a work group (such as work group 102 of FIG. 1) may access their user recognition space (such as user recognition space 200 of FIG. 2) and may give and receive recognition tokens. As illustrated, a plurality of computer systems 302 may be communicatively coupled to a server 306 via a communication network 304. The computer systems 302 may enable a user (such as a user 104 of FIG. 1) to view a respective user recognition space that is unique to each particular user. The computer system 302 may further enable each user to send and receive recognition tokens and nominations for recognition to/from other users. The computer system 302 may comprise any data processing system adapted to use processor readable data and to communicate via the communication network 304. By way of example and not limitation, the computer system 302 may comprise a desktop computer, a laptop computer, a notebook computer, a tablet computer, a smart phone (e.g., iPhone, Blackberry, Windows Mobile Device, etc.), or a personal media player (e.g., Zune, iPod, etc.).

The communication network 304 may comprise any wireless or wired data communication network, such as the internet, an intranet, other communication network, or any combination thereof. The communication network 304 may comprise a wide area network (WAN), a wireless WAN (WWAN), a local area network (LAN) and/or a wireless LAN (WLAN), and may employ one or more known protocols for facilitating the particular network implementation.

The server 306 may comprise any conventional server including a data processing system adapted to provide/receive data to/from one or more other computer systems 302. According to at least one feature, the server 306 may be adapted to store data associated with a plurality of user recognition spaces that include one or more of the various features described herein for user recognition spaces. The server 306 may be adapted to provide data associated with a user recognition space to one or more computer systems 302, and to store changes to the user recognition space. For example, the server 306 may provide data associated with a user recognition space to a computer system 302 so that a user may view and use their respective user recognition space. When the user sends or receives a recognition token, sends a nomination for recognition or makes some modification or customization to their personal user recognition space, the server 306 may track and store such activity and changes so that the user's respective user recognition space will reflect the changes for the next time that the user accesses their user recognition space from the server 306.

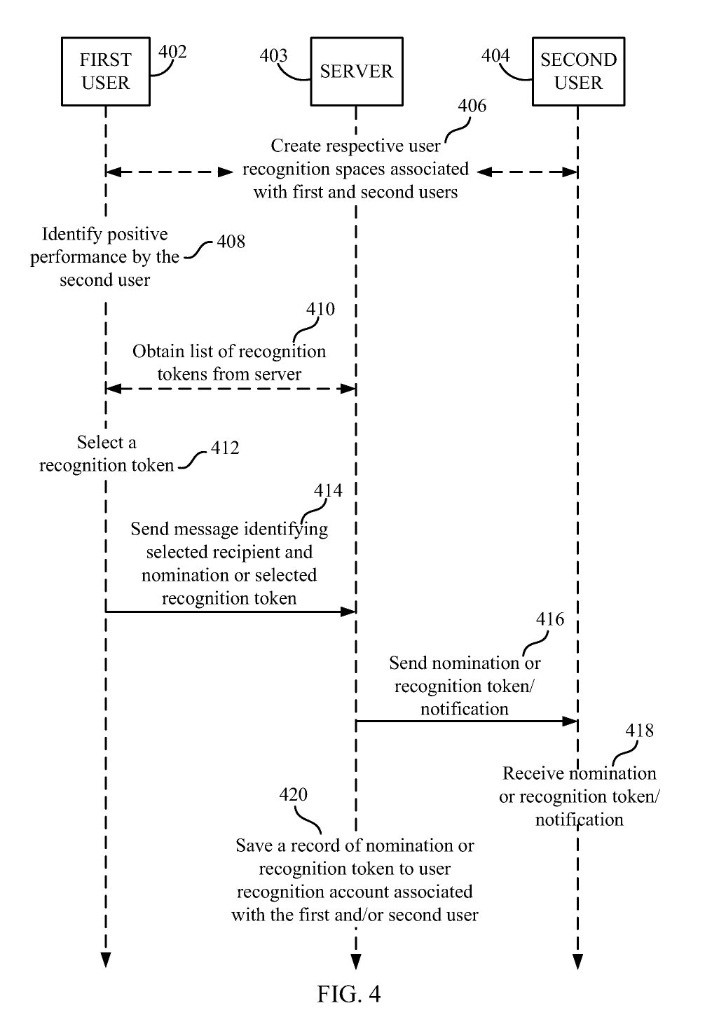

FIG. 4 is a flow diagram illustrating an operation of sending a recognition token or a nomination for recognition from a first user (using a computer system) and receiving the sent recognition or nomination by a second user (using a computer system), according to at least one example. Initially, a respective user recognition space is created 406 for a first user 402 and for a second user 404 at the server 403. That is, a user recognition space is created that is associated with the first user 402, and another user recognition space is created that is associated with the second user 404. These respective user recognition spaces may be created by a third party, by each respective user, or by the server 403.

Each user may then access their respective user recognition space from the server 403 (e.g., using a computer system 202 in FIG. 2). In due course, a user, such as the first user 402, may identify some positive performance by the second user 408. For example, the first user 402 and the second user 404 may be team members on a team at the same company. Over the course of working on a particular project, the first user 402 may identify some act or some result that the first user 402 feels merits some recognition for a job well done by the second user 404.

Using the associated recognition space displayed by a computer system, the first user 402 may, in some examples, obtain 410 a list of available recognition tokens from the server 403. For example, the computer system used by the first user 402 may send a request to the server 403 for a listing of some or all of the recognition tokens that the first user 402 is able to send to the second user 404. The first user 402 may then select 412 (e.g., via a graphical user interface) a recognition token from the group, which the first user 402 desires to send to the second user 404 in recognition of the identified positive performance 408. In one or more other examples, the first user 402 may nominate the second user 404 for recognition, in which case the first user 402 may not select the recognition token for the second user 404.

After identifying the second user 404 for recognition, a message 414 may be conveyed from the computer system used by the first user 402 to the server 403 identifying the nomination or the selected recognition token as well as the intended recipient (i.e., the second user 404). In examples where a recognition token is selected, the recognition token may comprise a virtual token sent via a communication network (e.g., communication network 204 in FIG. 2), a physical token, or some combination thereof. By way of example and not limitation, a virtual token may comprise an electronic message (e.g., a “thank you” message), an electronic graphic (e.g., a virtual trophy, a virtual gold star, etc.), a combination of a message and a graphic (e.g., an electronic card, electronic button), an award of a quantity of points that can be used by the recipient, or any other virtual gift or combination of virtual gifts. By way of example and not limitation, a physical token may comprise one or more of a physical certificate or trophy, a gift card, money, food, flowers, or any other physical gift.

The first user 402 may be required to select a recognition token from a finite group of recognition tokens. In some implementations, the recognition token or group of recognitions tokens may be predetermined based on the type of positive performance identified. In other implementations, the recognition token may be selected by the first user 402 as any award or gift the first user 402 may desire to send to the second user 404.

In examples where the first user 402 is nominating the second user 404 for recognition, the nomination may be directed to one or more approvers (not shown), where the nomination may be approved prior to being authorized for recognition to the second user 404.

Once the first user 402 has nominated the second user 404 (and the nomination is approved when applicable) or once the first user 402 has selected a recognition token and the intended recipient, a message 416 indicating the nomination or selected recognition token may be conveyed by the server 403 to the recognition space associated with the second user 404. In the case where the recognition token comprises solely one or more physical tokens, a notification may be sent to the second user 404 informing the second user 404 that a recognition token has been awarded and sent. In this way, the second user 404 receives some electronic message (either a recognition token or a notification) 418 in their associated user recognition space. Furthermore, a record of the received recognition token can be saved in the second user's associated user recognition space 420 by the server 403. In this manner, the second user 404 is able to retain a record of all the recognition tokens received, creating a history or record of the contributions the second user 404 has made to the company.

Furthermore, a record may also be saved 420 in the user recognition space associated with the first user 402. Saving a record of sent recognition tokens may result in a history for the first user 402 to be able to see what recognition has be given and how other users have contributed to the work group.

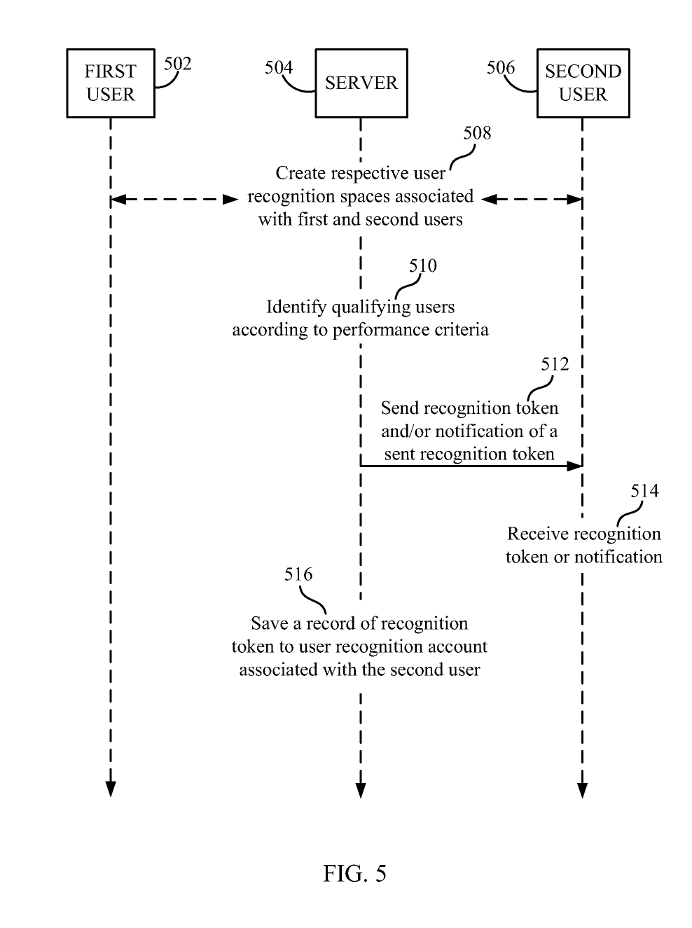

In other examples, a server 403 or other data processing system, as opposed to another user (e.g., the first user 402), can be adapted to identify those who qualify for a recognition token and to send the recognition token to each qualifying user. FIG. 5 is a flow diagram illustrating such an example according to at least one implementation.

Initially, a respective user recognition space is created 508 for one or more users, such as a first user 502 and a second user 506 at the server 504. That is, a user recognition space is created that is associated with the first user 502, and another user recognition space is created that is associated with the second user 506. These respective user recognition spaces may be created by a third party, by each respective user, or by the server 504.

The server 504, or other data processing system, is adapted to evaluate one or more performance criteria for one or more users and identify 510 one or more users who may qualify for a recognition token. According to such examples, an administrator of the performance recognition system may choose a prerequisite for one or more performance criteria, as well as one or more recognition tokens to be awarded to a user who meets or exceeds the predetermined performance criteria. By way of example and not limitation, a sales team may decide to offer each sales associate some reward for selling at least some predetermined amount of product for a given time period (e.g., 100 units in 2 months, or $40,000 in gross sales in 3 months, etc.). At the end of the time period, the server 504 may identify which associates met the sales goals, and the server 504 may select the predetermined recognition token to be sent to each qualifying associate.

Once the server 504 has identified each qualifying user and the selected recognition token, the selected recognition token may be conveyed by the server 504 to the qualifying user. In the example illustrated in FIG. 5, the second user 506 is identified as a qualifying user. Accordingly, a selected recognition token 512 is conveyed to the second user 506. In the case where the recognition token comprises solely one or more physical tokens, a notification may be sent to the second user 506 informing the second user 506 that a recognition token has been awarded and sent. In this way, the second user 506 receives some electronic message (either a recognition token or a notification) 514 in their associated user recognition space. Furthermore, a record of the received recognition token may be saved in the second user's associated user recognition space 516 by the server 504. In this manner, the second user 506 is able to retain a record of all the recognition tokens received, creating a history or record of the contributions the second user 506 has made to the company.

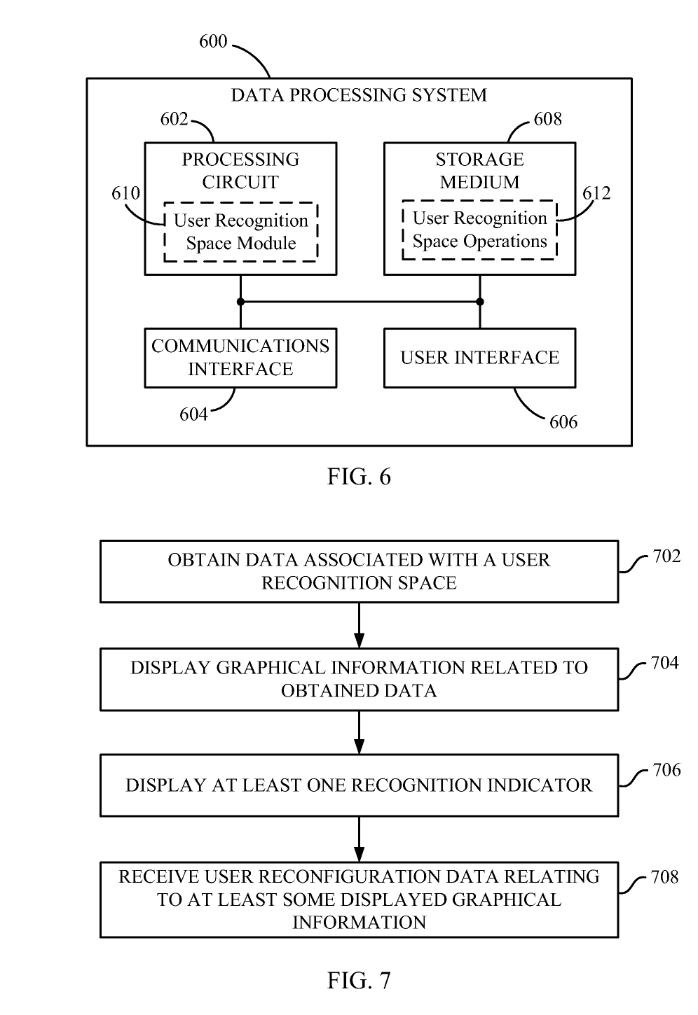

Turning to FIG. 6, a block diagram of a user data processing system 600 is shown according to at least one example. The data processing system 600 may include any of the features and/or may be adapted to perform any of the features described herein above with reference to a user data processing system in any or all of FIGS. 1-5. The data processing system 600 may generally include a processing circuit 602, a communications interface 604, a user interface 606, and a storage medium 608. It is noted that additional, fewer and/or different features and components may be included in data processing system 600 according to various examples.

The processing circuit 602 is arranged to obtain, process and/or send data, control data access and storage, issue commands, and control other desired operations. The processing circuit 602 may include circuitry configured to implement desired programming provided by appropriate media in at least one example. For instance, the processing circuit 602 may be implemented as one or more of a processor, a controller, a plurality of processors and/or other structure configured to execute executable instructions including, for example, software and/or firmware instructions, and/or hardware circuitry. Examples of the processing circuit 602 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor but, in the alternative, the processor may be any conventional processor, controller, microcontroller, or state machine. A processor may also be implemented as a combination of computing components, such as a combination of a DSP and a microprocessor, a number of microprocessors, one or more microprocessors in conjunction with a DSP core, or any other such configuration. These examples of the processing circuit 602 are for illustration and other suitable configurations within the scope of the present disclosure are also contemplated.

The processing circuit 602 is adapted for processing, including the execution of programming, which may be stored on the storage medium 608. In some instances, the processing circuit 602 may include a user recognition space module 610. The user recognition space module 610 may include circuitry and/or programming adapted to obtain data associated with a user recognition space and display graphical information related to the obtained data, as well as other functions associated with user recognition spaces, as described herein.

The communications interface 604 is configured to implement wireless and/or wired communications of the data processing system 600. For example, in some implementations, the communications interface 604 may be configured to communicate information bi-directionally with respect to one or more remote devices (e.g., other data processing system(s)) as well as other devices by means of a communication network (e.g., communication network 204 in FIG. 2). The communications interface 604 may be coupled with an antenna and may include wireless transceiver circuitry for wireless communications with wireless devices and may also include as a network interface card (NIC), serial or parallel connection, USB port, Firewire interface, flash memory interface, floppy disk drive, or any other suitable arrangement for communicating with respect to public (e.g., Internet) and/or private networks or other wired arrangements.

The user interface 606 is configured to facilitate user interaction with the data processing system 600, and may include a display, a keyboard, a mouse, a touch screen, a microphone, and/or a speaker, etc. A display may be adapted visually present images to a user (e.g., graphical user interface of a user recognition space). For example, the user interface 606 including a display may include a monitor, television, projector, or other device for visually presenting graphics to a user. According to some implementations, the data processing system 600 may not include a user interface 606 including a display coupled directly thereto. Instead, the data processing system 600 may convey data to be displayed by another data processing system to which the data processing system 600 is communicatively coupled (e.g., via internet or intranet).

The storage medium 608 may represent one or more devices for storing programming and/or data, such as processor-executable code or instructions (e.g., software, firmware), electronic data, databases, or other digital information. The storage medium 608 may also be used for storing data that is manipulated by the processing circuit 602 when executing programming. The storage medium 608 may be any available media that can be accessed by a general purpose or special purpose processor. By way of example and not limitation, the storage medium 608 may include a non-transitory computer-readable medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other non-transitory computer-readable mediums for storing information, as well as any combination thereof. The storage medium 608 may be coupled to, or at least accessible by the processing circuit 602 such that the processing circuit 602 can read information from, and write information to, the storage medium 608. In other examples, the storage medium 608 may be integral to the processing circuit 602.

Programming stored by the storage medium 608, when executed by the processing circuit 602, causes the processing circuit 602 to perform one or more of the various functions and/or process steps described herein. The storage medium 608 may include user recognition space operations 612. The user recognition space operations 612 can be implemented by the processing circuit 602 in, for example, the user recognition space module 610 to perform one or more of the various functions and/or process steps described herein with reference to any one of FIGS. 4, 5, 7, 8, 9 and/or 10. Thus, according to one or more aspects of the present disclosure, the processing circuit 602 may be adapted to perform any or all of the processes, functions, steps and/or routines for any or all of the data processing systems (e.g., computer system 302 of FIG. 3) associated with performance recognition and the conveyance of recognition tokens, as discussed throughout this disclosure. As used herein, the term “adapted” in relation to the processing circuit 602 may refer to the processing circuit 602 being one or more of configured, employed, implemented, or programmed to perform a particular process, function, step and/or routine according to various features described herein.

Turning to FIG. 7, a flow diagram is illustrated showing an example of at least one implementation of a method operational on a user data processing system, such as data processing system 600. Referring to both of FIGS. 6 and 7, a data processing system 600 may initially obtain data associated with a user recognition space at step 702. For example, a user may request access to a respective user recognition space, resulting in one or more messages being transmitted between the data processing system 600 and a server to obtain the data associated with the requested user recognition space. In some instances, the data processing system 600 may display a request for user login credentials (e.g., username, password) prior to receiving the requested data. Such login credentials may be transmitted from the data processing system 600 to the server, where the login is authenticated and the data associated with the requested user recognition space can be transmit back to the data processing system 600 via the communications interface 604.

At step 704, the data processing system 600 can display graphical information related to the obtained data. For example, the processing circuit 602 (e.g., the user recognition space module 610) may process the obtained data and display graphical information via the user interface 606 (e.g., a display) to the user. The displayed graphical information may include the user's respective user recognition space, which may include features relating to any of those illustrated in FIG. 2 described above. Accordingly, the user of the data processing system 600 can view and interact with their respective user recognition space.

At step 706, the data processing system 600 can display one or more recognition indicators. A recognition indicator may be adapted to indicate receipt of a recognition token, that a recognition token has been sent to another user by the user of the data processing system 600, and/or that a nomination has been submitted by the user of the data processing system 600 for recognition of another user. In at least some examples, the processing circuit 602 (e.g., the user recognition space module 610) may receive data associated with one or more recognition indicators. On receipt of such data associated with one or more recognition indicators, the processing circuit 602 (e.g., the user recognition space module 610) can display the recognition indicator using the user interface 606 (e.g., a display). Accordingly, the user can visually view an indication on their respective user recognition space for each recognition token that has been received or sent to another user, as well as any nominations submitted by the user for recognition of another user.

According to at least one feature, the data processing system 600 can also receive one or more inputs from a user to reconfigure at least some of the displayed graphical information related to the data associated with the user recognition space, as indicated at step 708. For example, the processing circuit 602 (e.g., the user recognition space module 610) may receive one or more inputs from a user via the user interface 606 to reconfigure at least some of the displayed graphical information. For instance, a user may use a mouse to move a graphic on their respective user recognition space, whereupon the processing circuit 602 (e.g., the user recognition space module 610) may store data related to the reconfiguration of the user recognition space. According to various instances, the processing circuit 602 may store the data related to the reconfiguration of the user recognition space at the storage medium 608 and/or at the server.

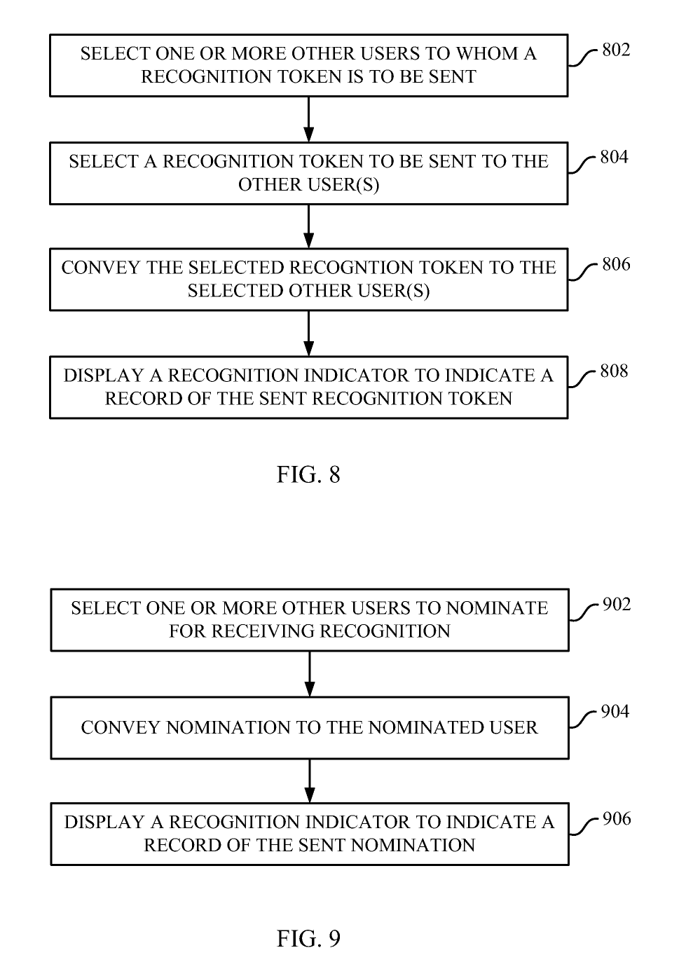

In some instances, the user of the data processing system 600 sends a recognition token to another user. FIG. 8 is a flow diagram illustrating an example of a method operational on the data processing system 600 according to at least one implementation for sending a recognition token to another user. In the illustrated method, it is assumed that a user of the data processing system 600 has already accessed their respective user recognition space. That is, it is assumed that the user of the data processing system 600 has already obtained data associated with a user recognition space from a server and that the data processing system 600 is already displaying graphical information related to the obtained data.

Referring to FIGS. 6 and 8, once the respective user recognition space is obtained and displayed for the user, the data processing system 600 may select at step 802 one or more other users to whom a recognition token is to be sent by the user of the data processing system 600. For example, a user may employ the user interface 606 (e.g., using a graphical user interface (GUI)) to select one or more other users to receive a recognition token that will be sent from the user. In at least some implementations, the processing circuit 602 (e.g., the user recognition space module 610) may obtain a list of possible recipients to whom the user can send a recognition token. For example, the processing circuit 602 may obtain such a list from the storage medium 608, the server or some other source. In other implementations, the user may input some identification (e.g., an email address, phone number, mailing address, etc.) to indicate a user to whom a recognition token is to be sent. The processing circuit 602 (e.g., the user recognition space module 610) can select the one or more other users in response to the input received from the user via the user interface 606.

At step 804, a recognition token may be selected to be sent to the selected other user or users. For example, the processing circuit 602 (e.g., the user recognition space module 610) may obtain and display a list of one or more recognition tokens available to be sent to the selected other user or users. Such a list of recognition tokens may be obtained from, for example, the storage medium 608, the server, or some other source. Using the user interface 606 (e.g., the graphical user interface (GUI)), the user can select the desired recognition token to be sent. In response to the input received from the user via the user interface 606, the processing circuit 602 (e.g., the user recognition space module 610) can select the recognition token to be sent to the one or more other users.

After selecting the recognition token and after identifying the one or more other users to receive the recognition token, the data processing system 600 may cause the recognition token to be conveyed to the one or more other users, at step 806. For example, the processing circuit 602 (e.g., the user recognition space module 610) may send a message to the other user, where the message includes the selected recognition token, or where the message identifies the recognition token selected for the other user. In other implementations, the processing circuit 602 (e.g., the user recognition space module 610) may send a message to the server, where the message identifies the one or more selected other users together with the selected recognition token. The server may subsequently associate the recognition token with the respective user recognition space for each of the selected one or more other users such that the one or more other users will be notified of the newly received recognition token.

At step 808, the data processing system 600 may display a recognition indicator to indicate that the recognition token has been sent to the one or more other users. For example, the processing circuit 602 (e.g., the user recognition space module 610) may display the recognition indicator using the user interface 606 (e.g., a display). Accordingly, the user can visually view an indication on their respective user recognition space for each recognition token has been sent to another user.

In some instances, the user of the data processing system 600 can send a nomination for one or more other users to receive recognition. FIG. 9 is a flow diagram illustrating an example of a method operational on the data processing system 600 according to at least one implementation for sending a nomination for another user to receive recognition. In the illustrated method, it is assumed that a user of the data processing system 600 has already accessed their respective user recognition space. That is, it is assumed that the user of the data processing system 600 has already obtained data associated with a user recognition space from a server and that the data processing system 600 is already displaying graphical information related to the obtained data.

Referring to FIGS. 6 and 9, once the respective user recognition space is obtained and displayed for the user, the data processing system 600 may select at step 902 one or more other users to nominate for receiving recognition. Such a nomination may include a nomination for the one or more other users to receive a recognition token or some other form of recognition. For example, a user may employ the user interface 606 (e.g., using a graphical user interface (GUI)) to select one or more other users to nominate for recognition. In at least some implementations, the processing circuit 602 (e.g., the user recognition space module 610) may obtain a list of possible recipients who the user can nominate. For example, the processing circuit 602 may obtain such a list from the storage medium 608, the server or some other source. In other implementations, the user may input some identification (e.g., an email address, phone number, mailing address, etc.) to indicate a nominated user. The processing circuit 602 (e.g., the user recognition space module 610) can select the one or more other users in response to the input received from the user via the user interface 606.

After identifying the one or more other users to be nominated for recognition, the data processing system 600 may cause the nomination to be conveyed to the one or more other users, at step 904. In some implementations, the processing circuit 602 (e.g., the user recognition space module 610) may convey the nomination to the nominated user. For example, the processing circuit 602 may send a message to the nominated user, where the message indicates the nomination. In other examples, the processing circuit 602 may send a message to the server, where the message identifies the one or more selected other nominated. The server may subsequently associate the nomination with the respective user recognition space for each of the selected one or more other users such that the one or more other users will be notified of the newly received nomination. In other implementations, the processing circuit 602 (e.g., the user recognition space module 610) may convey the nomination to one or more approvers before it is conveyed to the nominated user. The approver may be a supervisor, manager or some other person responsible to oversee, verify and/or approve nominations. According to various implementations, a plurality of approvers may be notified of the nomination and one or more of the plurality of approvers may be required to approve the nomination before a recognition token is finally sent to the nominated user(s).

At step 906, the data processing system 600 may display a recognition indicator to indicate that the nomination has been sent to the one or more other users. For example, the processing circuit 602 (e.g., the user recognition space module 610) may display the recognition indicator using the user interface 606 (e.g., a display). Accordingly, the user can visually view an indication on their respective user recognition space for each nomination submitted by the user for recognition of another user.

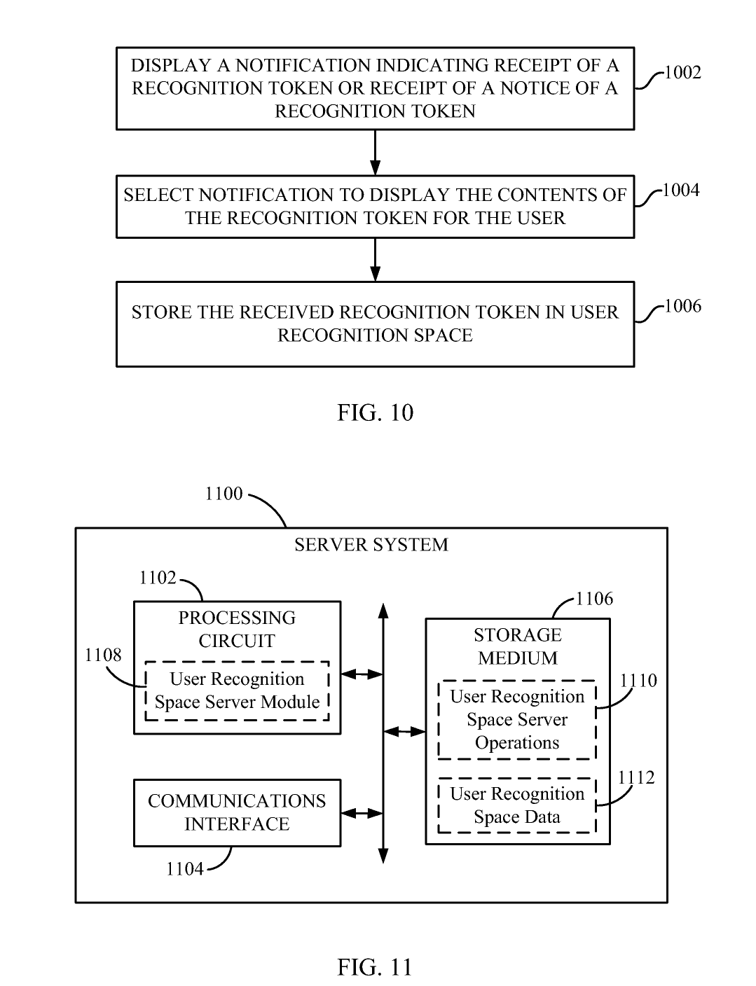

FIG. 10 is a flow diagram illustrating an example of a method operational on the data processing system 600 according to at least one implementation for receiving recognition token or a nomination for recognition. In the illustrated method, it is assumed that a user of the data processing system 600 has already accessed their respective user recognition space. That is, it is assumed that the user of the data processing system 600 has already obtained data associated with a user recognition space from a server.

Referring to FIGS. 6 and 10, once the respective user recognition space is obtained, the data processing system 600 may visually display a notification for the user indicating that a recognition token, a nomination, or a notice of a recognition token has been received, at step 1002. In at least some implementations, the notification may comprise the recognition token or the nomination itself being displayed in the user recognition space. For example, when a notification is received, the processing circuit 602 (e.g., the user recognition space module 610) may be adapted to display a visual notification for the user. A visual notification may include, for instance, a new recognition token or nomination being highlighted and/or displayed on the respective user recognition space, an account status indicating a number of newly received recognition tokens, or other form of visual notification.

At step 1004, the data processing system 600 may display the contents of the recognition token. For example, the processing circuit 602 (e.g., the user recognition space module 610) may receive an input via the user interface 606 selecting a graphical representation in the displayed user recognition space of a particular notification, whereupon the processing circuit 602 (e.g., the user recognition space module 610) may obtain and display the contents of the recognition token associated with the notification via the user interface 606.

At step 1006, the data processing system 600 can store data associated with the received recognition token with the data associated with the user recognition space so that the recognition token can be displayed with other received recognition tokens. For example, the processing circuit 602 (e.g., the user recognition space module 610) may cause data associated with the received recognition token to be stored with the data associated with the user recognition space at, for example, the storage medium 608 or the server. In this manner, a history of received recognition tokens can be created and visually displayed to the user any time the user recognition space is accessed.

Turning to FIG. 11, a block diagram of a data processing system implemented as a server is illustrated, according to at least one example. The server 1100 may generally include a processing circuit 1102, a communications interface 1104, and a storage medium 1106. It is noted that additional, fewer and/or different features and components may be included in data processing system 1100 according to various examples.

The processing circuit 1102 is arranged to obtain, process and/or send data, control data access and storage, issue commands, and control other desired operations. The processing circuit 1102 may include circuitry configured to implement desired programming provided by appropriate media in at least one example. For instance, the processing circuit 1102 may be implemented as one or more of a processor, a controller, a plurality of processors and/or other structure configured to execute executable instructions including, for example, software and/or firmware instructions, and/or hardware circuitry. Examples of the processing circuit 1102 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may be a microprocessor but, in the alternative, the processor may be any conventional processor, controller, microcontroller, or state machine. A processor may also be implemented as a combination of computing components, such as a combination of a DSP and a microprocessor, a number of microprocessors, one or more microprocessors in conjunction with a DSP core, or any other such configuration. These examples of the processing circuit 1102 are for illustration and other suitable configurations within the scope of the present disclosure are also contemplated.

The processing circuit 1102 is adapted for processing, including the execution of programming, which may be stored on the storage medium 1106. In some instances, the processing circuit 1102 may include a user recognition space server module 1108. The user recognition space server module 1108 may include circuitry and/or programming adapted to store data associated with one or more user recognition spaces, and provide at least some of the data to one or more data processing systems, as well as other functions associated with user recognition spaces, as described herein.

The communications interface 1104 is configured to implement wireless and/or wired communications of the data processing system 1100. For example, in some implementations, the communications interface 1104 may be configured to communicate information bi-directionally with respect to one or more remote devices (e.g., user data processing system(s)) as well as other devices by means of a communication network (e.g., communication network 204 in FIG. 2). The communications interface 1104 may be coupled with an antenna and may include wireless transceiver circuitry for wireless communications with wireless devices and may also include as a network interface card (NIC), serial or parallel connection, USB port, Firewire interface, flash memory interface, floppy disk drive, or any other suitable arrangement for communicating with respect to public (e.g., Internet) and/or private networks or other wired arrangements.

The storage medium 1106 may represent one or more devices for storing programming and/or data, such as processor-executable code or instructions (e.g., software, firmware), electronic data, databases, or other digital information. The storage medium 1106 may also be used for storing data that is manipulated by the processing circuit 1102 when executing programming. The storage medium 1106 may be any available media that can be accessed by a general purpose or special purpose processor. By way of example and not limitation, the storage medium 1106 may include a non-transitory computer-readable medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other non-transitory computer-readable mediums for storing information, as well as any combination thereof. The storage medium 1106 may be coupled to, or at least accessible by the processing circuit 1102 such that the processing circuit 1102 can read information from, and write information to, the storage medium 1106. In other examples, the storage medium 1106 may be integral to the processing circuit 1102.

Programming stored by the storage medium 1106, when executed by the processing circuit 1102, causes the processing circuit 1102 to perform one or more of the various functions and/or process steps described herein. The storage medium 1106 may include user recognition space server operations 1110. The user recognition space server operations 1110 can be implemented by the processing circuit 1102 in, for example, the user recognition space server module 1108 to perform any or all of the processes, functions, steps and/or routines for any or all of the servers described herein (e.g., server 306 of FIG. 3, server 403 of FIG. 4, server 504 of FIG. 5). As used herein, the term “adapted” in relation to the processing circuit 1102 may refer to the processing circuit 1102 being one or more of configured, employed, implemented, or programmed to perform a particular process, function, step and/or routine according to various features described herein. In addition to the user recognition space server operation 1110, the storage medium 1106 may also include data 1112 associated with one or more user recognition spaces. The user recognition space data 1112 includes data sufficient to enable a user data processing system to display a user recognition space for a user when obtained by the user data processing system.

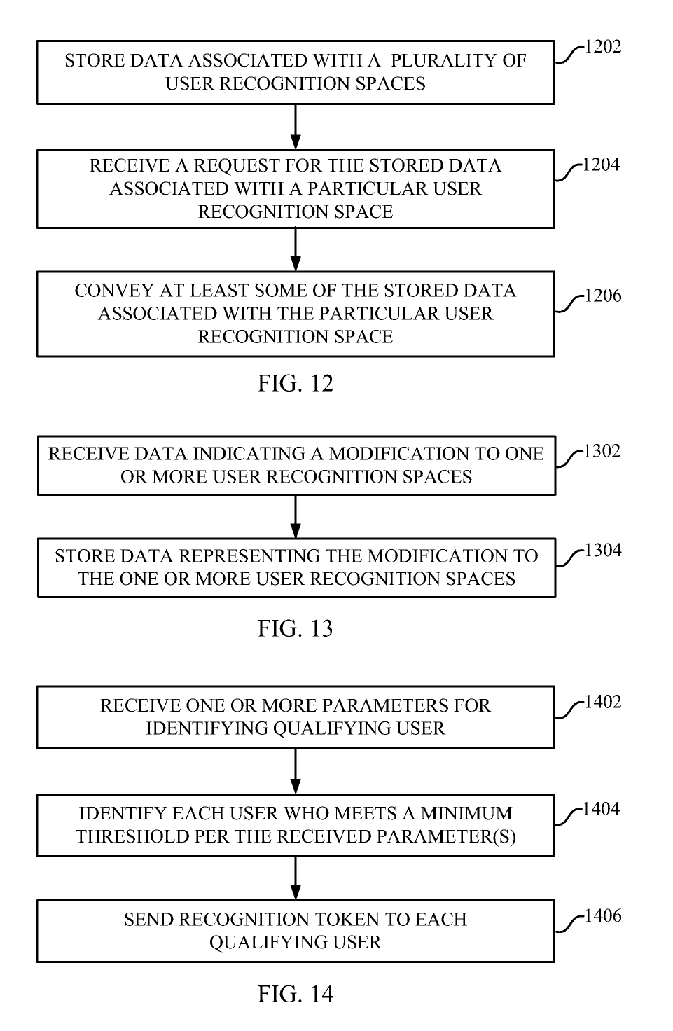

Turning to FIG. 12, a flow diagram is illustrated showing an example of at least one implementation of a method operational on a server, such as server 1100. Referring to both of FIGS. 11 and 12, a server 1100 may, at step 1202, store data associated with a plurality of user recognition spaces, where each user recognition space is associated with a respective user. For instance, the processing circuit 1102 (e.g., the user recognition space server module 1108) may store user recognition space data 1112 for a plurality of user recognition spaces in the storage medium 1106. As noted herein, each user recognition space can be adapted to, among other things, enable a respective user to send and receive recognition tokens and/or nominations for recognition.

At step 1204, the server 1100 may receive a request for the stored data associated with a particular user recognition space. For example, the processing circuit 1102 (e.g., the user recognition space server module 1108) may receive a request from a user data processing system via the communications interface 1104. The received request may comprise a single communication or a plurality of communications between the server 1100 and the requesting user data processing system. In at least some instances, the request can include an identification of the particular user recognition space, and may also include one or more forms of access authentication. For example, the request may include a username identifying the user recognition space as well as a password.

At step 1206, the server 1100 can convey at least some of the stored data associated with the particular user recognition space to the user data processing system. For example, the processing circuit 1102 (e.g., the user recognition space server module 1108) may send one or more transmissions via the communications interface 1104, where the one or more transmissions include at least some of the user recognition space data 1112 associated with the particular user recognition space.

In some instances, the data associated with one or more user recognition spaces may be modified. For example, a modification may include a recognition token or a nomination for recognition being sent or received by a user using a respective user recognition space such that a recognition indicator is added to the user recognition space. In other examples, some user customizable feature of a user recognition space may be modified, such as a background color, a mascot graphic, an image or photo, a nametag, and/or a flag. FIG. 13 is a flow diagram illustrating an example of a method operational on the server 1100 according to at least one implementation for facilitating a modification to a user recognition space.

Referring to FIGS. 11 and 13, the server 1100 may receive data indicating a modification to the particular user recognition space, at step 1302. For example, the processing circuit 1102 (e.g., the user recognition space server module 1108) may receive a communication via the communications interface 1104 that indicates one or more modifications to at least one user recognition space.

Upon receipt, the server 1100 can store data representing the modification to the one or more user recognition spaces at step 1304. For example, the processing circuit 1102 (e.g., the user recognition space server module 1108) may store data representing the modification with the user recognition space data 1112 in the storage medium 1106 so that the modification will be represented on the respective user recognition space when it is accessed by a user.

Turning to FIG. 14, a flow diagram is illustrated showing an example of a method operational on the server 1100 according to at least one implementation for sending a recognition token to a user. With reference to FIGS. 11 and 14, the server 1100 may obtain one or more parameters for identifying a qualifying user at step 1402. For instance, the processing circuit 1102 (e.g., the user recognition space server module 1108) may receive one or more parameters defining requirements to be met by users for qualifying to receive a recognition token. By way of example and not limitation, the one or more parameters may include a time frame (e.g., 3 months) and/or one or more performance parameters (sales of $10,000 per month average, meets three of four deadlines, etc.).

At step 1404, the server 1100 can identify each user who meets the minimum requirements as defined by the received parameters. For example, the processing circuit 1102 (e.g., the user recognition space server module 1108) may compare one or more users statistics to the one or more received parameters to identify each user who meets the minimum requirements as defined by the received parameters. By way of an illustrative example and not limitation, the processing circuit 1102 (e.g., the user recognition space server module 1108) may identify each user who has an average of $10,000 of average sales for 3 months.

At step 1406, the server 1100 can send a recognition token to each qualifying user. For instance, the server 1100 may cause a new recognition token to be associated with the user recognition space for each qualifying user. By way of example, the processing circuit 1102 (e.g., the user recognition space server module 1108) may store data representing a modification to the user recognition space associated with each qualifying user. Accordingly, when a qualifying user accesses their respective user recognition space, the user can receive the recognition token.

One or more of the components, steps, features and/or functions illustrated in FIGS. 2, 3, 4, 5, 6, 7, 8, 9, 10, 11, 12, 13 and/or 14 may be rearranged and/or combined into a single component, step, feature or function or embodied in several components, steps, or functions. Additional elements, components, steps, and/or functions may also be added without departing from the disclosure. The apparatus, devices, and/or components illustrated in FIGS. 3, 6 and/or 11 may be configured to include one or more of the features or to perform one or more of the methods, features, or steps described with reference to FIGS. 2, 4, 5, 7, 8, 9, 10, 12, 13 and/or 14. The novel algorithms described herein may also be efficiently implemented in software, firmware and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Moreover, examples may be implemented by hardware, software, firmware, middleware, microcode, or any combination thereof. When implemented in software, firmware, middleware or microcode, the program code or code segments to perform the necessary tasks may be stored in a machine-readable medium such as a non-transitory storage medium or other storage(s). A processor may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

Those of skill in the art would further appreciate that the various illustrative logical blocks, modules, circuits, and algorithm steps described in connection with the examples disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Furthermore, programming adapted to perform one or more of the various steps or processes described creates a new machine, because a general purpose computer in effect becomes a special purpose computer once it is programmed to perform particular functions pursuant to instructions from program software.

The present invention may be embodied in other specific forms without departing from its structures, methods, or other essential characteristics as broadly described herein and claimed hereinafter. The described embodiments are to be considered in all respects only as illustrative, and not restrictive. The scope of the invention is, therefore, indicated by the appended claims, rather than by the foregoing description. All changes that come within the meaning and range of equivalency of the claims are to be embraced within their scope.

What is claimed is:

1. A data processing system, comprising:
a communications interface adapted to communicate via a communications network;
a display adapted to visually represent graphical data; and
a processing circuit coupled to the communications interface and the display, the processing circuit adapted to:
obtain data associated with a user recognition space via the communications interface;
display graphical information related to the data associated with the user recognition space; and
display at least one recognition indicator.

2. The data processing system of claim 1, wherein the at least one recognition indicator is adapted to indicate an event selected from a group of events comprising:
receipt of a recognition token;
that a recognition token has been sent to another user; and
that a nomination has been submitted for recognition of another user.

3. The data processing system of claim 1, wherein the processing circuit is further adapted to:
select, in response to an input by a user, another user to whom a recognition token is to be sent;
select, in response to another input by the user, a recognition token to be sent to the other user;
convey the recognition token to the other user; and
display a recognition indicator adapted to indicate a record of the recognition token sent to the other user.

4. The data processing system of claim 3, wherein the recognition token comprises at least one type of recognition token selected from a group of recognition token types comprising a virtual recognition token and a physical recognition token.

5. The data processing system of claim 1, wherein the obtained data includes a received recognition token or a received notice of a recognition token, and the processing circuit is further adapted to:
display a notification indicating receipt of the recognition token or the notice of a recognition token.

6. The data processing system of claim 1, wherein the processing circuit is further adapted to:
receive an input from a user to reconfigure at least some of the displayed graphical information related to the data associated with the user recognition space; and
store data related to the input from the user to reconfigure the at least some of the displayed graphical information.

7. The data processing system of claim 1, wherein the processing circuit is further adapted to:
select, in response to an input by a user, another user to nominate for receiving recognition;
convey a nomination message to the other user indicating their nomination for receiving recognition; and
display a recognition indicator adapted to indicate a record of the nomination sent to the other user.

8. A method operational on a data processing system, comprising:
obtaining data associated with a user recognition space;
displaying graphical information related to the data associated with the user recognition space; and
displaying at least one recognition indicator.

9. The method of claim 8, wherein a recognition indicator is adapted to indicate receipt of a recognition token, that a recognition token has been sent to another user, or that a nomination has been submitted for recognition of another user.

10. The method of claim 8, wherein obtaining the data associated with the user recognition space comprises:
sending to a server a request for the data associated with the user recognition space; and
receiving in response to the request a transmission including at least some of the data associated with the user recognition space.

11. The method of claim 8, further comprising:
receiving an input selecting another user to whom a recognition token is to be sent;
receiving another input selecting a recognition token to be sent to the other user;
conveying the recognition token to the other user; and
displaying a recognition indicator adapted to indicate a record of the recognition token sent to the other user.

12. The method of claim 11, wherein conveying the recognition token to the other user includes:
sending a transmission to a server to affect delivery of the recognition token to the other user.

13. The method of claim 8, further comprising:
displaying a notification indicating receipt of a recognition token.

14. The method of claim 13, further comprising:
selecting, in response to an input by a user, the displayed notification; and
displaying the contents of the recognition token associated with the notification.

15. The method of claim 8, further comprising:
receiving an input from a user to reconfigure at least some of the displayed graphical information related to the data associated with the user recognition space; and
storing data related to the reconfiguration of the at least some of the displayed graphical information.

16. The method of claim 8, further comprising:
receiving an input selecting another user to nominate for receiving recognition;
conveying a nomination message to the other user indicating their nomination for receiving recognition; and
displaying a recognition indicator adapted to indicate a record of the nomination sent to the other user.

17. The method of claim 16, wherein conveying the nomination message to the other user comprises:
sending a nomination message to an approver, wherein the nomination message is conveyed to the other user after the nomination is approved by the approver.

18. A processor-readable medium including one or more instructions operational on a data processing system, which when executed by a processor causes the processor to:
obtain data associated with a user recognition space;
display graphical information related to the data associated with the user recognition space; and
display at least one recognition indicator.

19. The processor-readable medium of claim 18, wherein the at least one recognition indicator is adapted to indicate an event selected from a group of events comprising:
receipt of a recognition token;
that a recognition token has been sent to another user; and
that a nomination has been submitted for recognition of another user.

20. The processor-readable medium of claim 18, further including one or more instructions operational on the data processing system, which when executed by the processor causes the processor to:
receive an input selecting another user to whom a recognition token is to be sent;
receive another input selecting a recognition token to be sent to the other user;
convey the selected recognition token to the selected other user; and
display a recognition indicator adapted to indicate a record of the recognition token sent to the other user.

21. The processor-readable medium of claim 18, further including one or more instructions operational on the data processing system, which when executed by the processor causes the processor to:
display a notification indicating receipt of a recognition token or a notice of a recognition token.

22. The processor-readable medium of claim 18, further including one or more instructions operational on the data processing system, which when executed by the processor causes the processor to:
reconfigure at least some of the displayed graphical information related to the data associated with the user recognition space in response to a received input; and
store data related to the reconfiguration of the at least some of the displayed graphical information.

23. The processor-readable medium of claim 18, further including one or more instructions operational on the data processing system, which when executed by the processor causes the processor to:
select another user to nominate for receiving recognition in response to an input from a user;
convey a nomination message to the other user indicating their nomination for receiving recognition; and
display a recognition indicator adapted to indicate a record of the nomination sent to the other user.
